(19) United States
(12) Patent Application Publication
(10) Pub. No.: US 2013/0104237 A1
(43) Pub. Date: Apr. 25, 2013

(54) Managing Risk Associated With Various Transactions

(71) Applicant: Bank of America, Charlotte, NC (US)

(72) Inventors: Mary K. Riley, Denver, NC (US); Todd Keith Inskeep, Charlotte, NC (US); Xu He, Charlotte, NC (US); David Scott Sappenfield, Charlotte, NC (US)

(73) Assignee: Bank of America, Charlotte, NC (US)

(21) Appl. No.: 13/709,514

(22) Filed: Dec. 10, 2012

Related U.S. Application Data
(62) Division of application No. 12/045,387, filed on Mar. 10, 2008.
(60) Provisional application No. 61/066,133, filed on Jul. 27, 2007.

(51) Int. Cl. H04L 29/06; G06Q 10/10

(52) U.S. Cl. CPC H04L 63/1433
USPC 726/25

(57) ABSTRACT

Systems, methods and consumer-readable media for managing risk associated with various transactions are provided. Such methods may include identifying a consumer-based software application for analysis and classifying the consumer-based software application into a plurality of consumer-facing transactions. Each consumer-facing transaction may be rated according to at least one category or criteria. Further, each rating may be converted into a numeric value. Another aspect of the invention may relate to receiving an identification of a list of threats to each of the consumer-facing transactions. These threats may be categorized into threat categories. The impact of each of the threats may be forecasted. The overall impact of the threats as forecasted may be calculated. Yet another aspect of the invention may relate to receiving an identification of a plurality of threat controls that control at least a portion of the plurality of threats.

This application is a division of pending U.S. application Ser. No. 12/045,387, filed Mar. 10, 2008, entitled “Managing Risk Associated with Various Transactions,” which claims priority to expired U.S. Application No. 61/066,133, entitled “Managing Risk Associated with Various Transactions” which was filed on Jul. 27, 2007. The contents of each of these applications are herein incorporated by reference in their entirety.

### FIELD OF TECHNOLOGY

Aspects of the disclosure relate to information security services. More specifically, aspects of the disclosure relate to a system and method for identifying and addressing information security and business continuity threats and for measuring risk associated with various transactions.

### BACKGROUND

Many business entities and organizations operate with a large technological information infrastructure for handling business operations. Whether with respect to particular interfaces with customers or suppliers, or internal interfaces between different departments of an organization, such as financial and engineering, organizations and business entities rely on computerized networks for many, if not all facets of operation.

As with any computer network, the potential for a threat to the network exists. In an organization or business entity, the threat can arise from many sources. In some instances, a threat source may originate from external sources, such as customers, competitors, and other non-related businesses that have some form of electronic access to the organization's computer network. In other instances, a threat source may originate internally, from a satellite office, a department, an operation or process of the organization, or implementation of a new internal technology. Still other threats may originate from direct business partners, suppliers, or still other sources.

In addition to the sources or origins of the threats, any of a number of different types of threats may occur. Although malicious type threats occur, many threat sources and types may not be even intentional. A threat is merely anything that could harm an asset, that is, anything with value that is desired to be protected. A vulnerability is a deficiency that leaves an asset open to harm. When exposure occurs, e.g., the harm that occurs when a threat becomes real, countermeasures are the resource to mitigate exposure and affect a threat or threat source.

Implementing a strategy to address the risk associated with threats continues to be a need of any organization. When a threat occurs at a business entity and it cannot recover in an immediate manner, the results could lead to revenue losses, customer or supplier losses, goodwill deterioration, and/or shareholder losses. As business entities operate across multiple locations, the impact on one business unit can inevitably affect other business units. As such, organizations have looked to prepare for threats that may occur rather than merely be reactive.

No system exists to correlate current and forecasted threats to projects and initiatives factoring in current and forecasted controls. An organization is currently unable to provide a single integrated view of critical operational risk components and risk assessment data. This limitation forces risk control resource allocations and strategic risk/reward decisions to be based upon disparate and often subjective information. This problem is evidenced by audits and vulnerability assessments continually exposing additional risks in every environment, line of business challenges in determining how to properly respond to operational risks, and increasing operational loss events.

Many observations, audits, vulnerability assessments, risk assessments, and the like, surface a large number of risks in the current environment. As these risks are surfaced, lines of businesses are challenged with determining how to respond to the risks identified. Challenges include determining how to best prioritize identified risks and how to load balance resources to respond. Additionally, knowing that not all risks can be controlled or optimized there is limited strategy currently available that assists with forward projection of risk.

What is needed is a system and method that enables an organization to proactively identify Information Security and Business Continuity (ISBC) threats related to a project or strategic initiative within a line of business and the controls associated with these threats.

In order to appropriately react to risks associated with various transactions supported by differing systems and applications, the risks should be quantified. Furthermore, risk metrics can change as threats, countermeasures, and controls change or evolve over time. Companies need processes to measure that risk in a consistent and standardized way. Such processes should also be able to adapt to changes in risk metrics and associated parameters.

Accordingly, it would be desirable to provide systems and methods for measuring and quantifying risk associated with various transactions. Still further, it would be desirable to provide systems and methods for deconstructing an application or process that includes transactions that are customer facing.

### BRIEF SUMMARY

It is an object of this invention to provide systems and methods for measuring and quantifying risk associated with various transactions. One method according to the invention may include identifying a consumer-based software application for risk analysis. The method may further include classifying the consumer-based software application into a plurality of user- or consumer-facing transactions. A user- or consumer-facing transaction may be considered for the purposes of this patent application a transaction in which a user or consumer interacts with an enterprise-based software application. The term customer-facing as used herein should be further understood to refer to any user-facing or customer-facing application.

The method may further include rating each transaction according to at least one category or criteria. Other alternative embodiments may relate to rating each transaction with respect to quality controls associated with the transaction. The method may also include converting each rating and/or quality control rating into a numeric value.

Another method relating to classifying the threats to the consumer-facing application includes the following steps—receiving an identification of a plurality of threats to a consumer transaction in a consumer-based software application, and receiving an identification of a plurality of threat controls that control at least a portion of the plurality of threats. This method may further include identifying control effectiveness against each of the plurality of threats. This method may also include calculating an overall effectiveness of the controls in terms of an overall effectiveness score with respect to mitigating the effect of the threats on the transaction.

In accordance with another aspect of the present invention, a system and method determines residual business risks by correlating threats, controls, business continuity factors, and other general risk considerations. Requirements of an initiative of a project are mapped to a taxonomy, and the mapped requirements are rated with respect to its importance to the project. Projected changes in the mapped requirements are forecasted over a specified period of time, such as an eighteen month period. A threat to the project is mapped to the taxonomy, and the mapped threat is rated with respect to its impact on the project. Projected changes in the effectiveness of the control are forecasted based upon historical data, a maturity rating, and the rated effectiveness of the control. Residual risk associated with the project is then determined, and adjustments to one or more resources associated with the project may be made to reduce the determined residual risk.

In accordance with at least one aspect of the present invention, a prioritized list of threats to a project may be identified, and a correlation of active controls to known threats may be made. A net residual risk inclusive of all mitigating controls may be taken into account. A forecasted change of the risk landscape may be determined by historical and current data regarding the residual risk to identify certain risk factors for all components with respect to a business initiative. Thus, relative ranking of strategic initiatives may be made to know risk associated with various types of projects and corresponding initiatives.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIGS. 1A-1B are a transaction risk assessment process flow diagram in accordance with at least one aspect of the present invention;

FIG. 2 is an risk assessment process in accordance with at least one aspect of the present invention;

FIG. 3 is a block diagram of a system that may be used to implement the processes and functions of certain aspects of the present invention;

FIG. 4 is a block diagram of a workstation and a server that may be used to implement the processes and functions of certain embodiments of the present invention;

FIG. 5 illustrates a schematic diagram of a general-purpose digital computing environment in which one or more aspects of the present invention may be implemented;

FIG. 6 is an example flowchart illustrating questions asked and steps taken to model threats and their potential impact on a business entity in accordance with at least one aspect of the present invention;

FIG. 7 is an illustrative equation for the interaction and uses of various libraries in accordance with at least one aspect of the present invention;

FIG. 8 illustrates an example block diagram of interactions between various components in accordance with at least one aspect of the present invention;

FIG. 9 is an example flowchart illustrating a process for forecasting risk associated with a project in accordance with at least one aspect of the present invention;

FIG. 10 is an example flowchart illustrating a process for addressing business initiatives in accordance with at least one aspect of the present invention;

FIG. 11 is an example flowchart illustrating a process for rating threats in accordance with at least one aspect of the present invention;

FIG. 12 is an example flowchart illustrating a process for maintaining a control library in accordance with at least one aspect of the present invention;

FIG. 13 is an example flowchart illustrating a process for determining a relationship between a business driver and a forecasted threat in accordance with at least one aspect of the present invention; and

FIG. 14 is a block diagram of an illustrative tree identifying various components of a business driver/initiative and a forecasted threat in accordance with at least one aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

A risk assessment process according to one or more aspects of the present invention provides a consistent, substantially standardized, scalable and re-usable process to measure a level of risk associated with one or more specific transactions within applications. The process may be generic and may be re-used by companies in various fields with different transactions, different applications, and even different countermeasures, while still providing risk scores that may be used to support related decisions and strategy.

Various embodiments of the risk assessment process in accordance with one or more aspects of the present invention may identify and quantify the level of risk, such as by a transaction-based analysis, associated with a customer, or other suitable user, interfacing with a product and/or service. The process may identify security threats and access current available controls associated with a particular threat. The process may further forecast, in an effort to determine, the controls' effectiveness in protecting against the threat.

In one embodiment of the invention, the process may assess customer-facing transactions. A first step of the process may identify the total risk level of the transactions. A second step may identify the transactions' controls. Another step may calculate the residual risk level of the transactions following the implementation of the controls.

Such a process preferably provides knowledge of where and which controls to implement. Particularly, the process enables the controls to be installed at the transaction level of the products/services and, thereby, to be closely tailored to the characteristics of the risk.

One problem that a method according to the invention may solve is as follows. Many organizations need ways to understand and manage the risk associated with the services they provide to customers, partners, and employees. A generic risk assessment process according to the invention may be used by any organization, financial services or other that needs to perform repeatable and scalable risk assessments. One particular embodiment of a risk assessment process according to the invention may enable adherence to the FFIEC (Federal Financial Institutions Examination Council) Authentication Guidance.

The guidance, issued on Oct. 12, 2005, updates the FFIEC's guidance entitled Authentication in an Electronic Banking Environment issued in 2001. It addresses the need for risk based assessments, customer awareness, and enhanced security measures to authenticate customers using Internet-based products and services that process high risk transactions involving access to customer information or the movement of funds to other parties. One such illustrative transaction which requires authentication is an ATM (Automated Teller Machine)-based transaction. A method according to the invention may be applied to analyze the risks associated with such a transaction. Additionally, methods according to the invention may be implemented in any suitable transaction-based risk analysis. Prior to FFIEC Authentication Guidance, financial institutions did not have a process to perform products/services transaction risk assessments.

The process according to one or more aspects of the invention provides a substantially consistent way to measure transaction risk in any application/product in any line of business across an enterprise. In another embodiment of the invention, the systems and methods may be applied to transaction-based analysis of factors other than risks. One such factor may be quality assurance. Accordingly, the processes disclosed herein may be applied to quantification of measures of quality assurance such as formulation of a quality assurance index, threats to quality assurance, controls of such threats and residual effects of the threats on the quality assurance index following the implementation of the controls on the threats.

One aspect of a process according to one or more aspects the invention is a risk assessment methodology. Specifically, the process may identify customers facing services/applications that may be implicated by heightened risk, identify transactions, identify threats, identify controls that may be used to response to the threats, and measure the effectiveness of controls on transactions against threats.

Another aspect of the process according to the invention relates to providing a multi-layered control environment. Such layers may include identified front door controls, transaction controls, back end controls, and/or associate controls.

Yet another aspect of the invention relates to the various inputs for risk assessment. A risk assessment process according to one or more aspects of the invention takes a broad array of inputs. The process may use the broad array of inputs to assess risk at a much more granular level, e.g., in one embodiment, risk may be assessed at the level of the individual transactions.

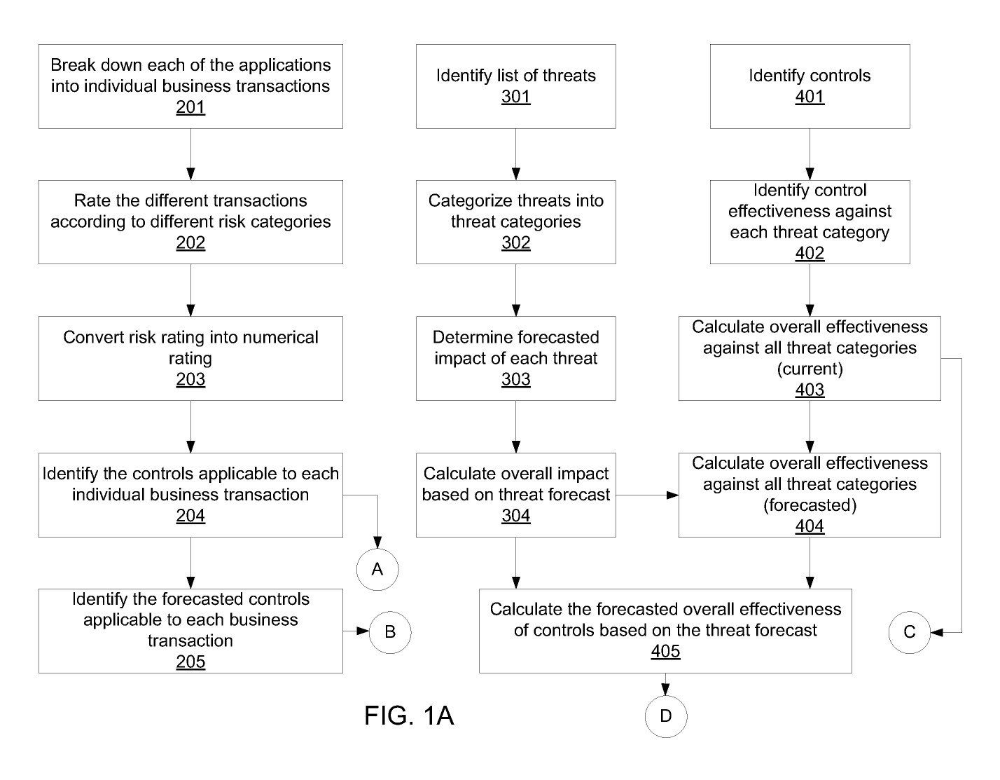

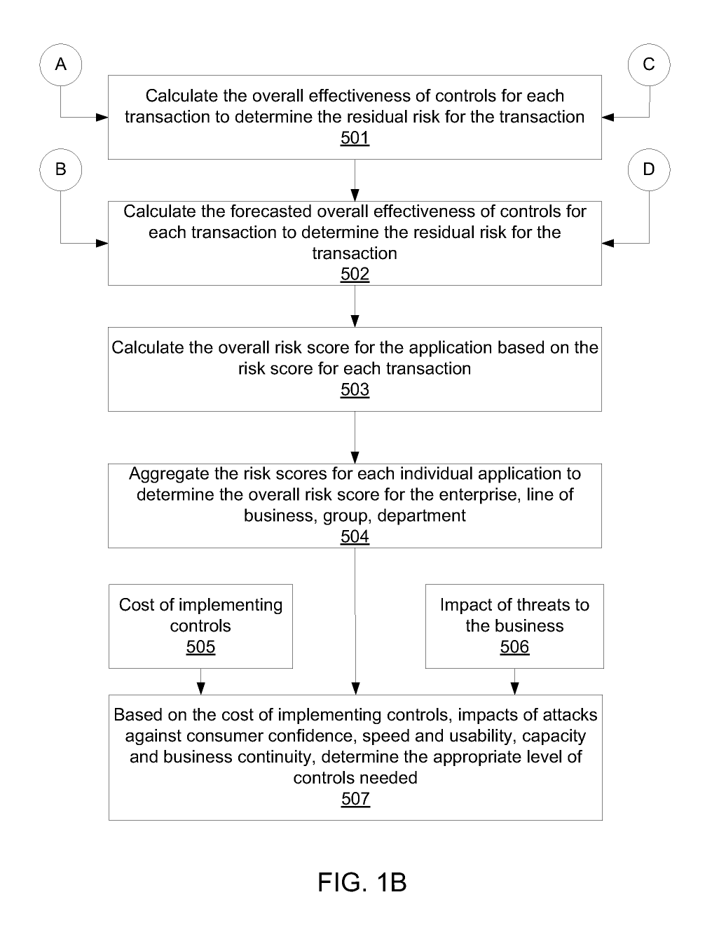

FIGS. 1A-1B show a transaction risk assessment process flow diagram according to one or more aspects of the invention. At step 201, each of the applications is broken down into its individual business transactions. At step 202, the different individual transactions are rated according to different risk categories such as transaction risk, reputation risk, and financial liability risk. Proceeding to step 203, the risk ratings are converted into a numerical rating with a value that may be used for numeric ranking.

Moving to step 204, the controls applicable to each individual business transaction are identified. From step 204, two paths may be followed according to the invention. A first path may identify the forecasted/projected controls applicable to each business transaction, as shown in step 205. A second path may calculate the overall effectiveness of controls for each transaction to determine the residual risk for the transaction, as shown in step 501 in FIG. 1B.

From step 205, the system may calculate the forecasted overall effectiveness of control to determine the residual risk for the transaction as shown in step 502 in FIG. 1B. An alternative path to step 205 may be taken through step 501.

Returning to FIG. 1A, at step 301, a list of threats are identified for each type of transaction. At step 302, the identified threats are categorized into threat categories. The impact of each threat may be forecasted in step 303. Proceeding to step 304, an overall impact is calculated based on the previously-determined threat forecast.

Thereafter, in step 405, the forecasted overall effectiveness of controls based on the threat forecast may be calculated. In another path from step 304, at step 404, an overall effectiveness against all of the forecasted threat categories may be calculated.

At step 401, controls may be identified that may be used to deal with the threat different types of threat categories. Moving to step 402, the control effectiveness against each threat category, and/or each individual threat, may be identified.

At step 403, the overall effectiveness against all current threat categories may be calculated. In the illustrative example, two paths are shown as available from step 403. First, at step 404, the overall effectiveness against the forecasted threat categories may be calculated as described above. Additionally, another path exists directly from step 403 to step 501, shown in FIG. 1B, where the overall effectiveness of controls for each transaction may be calculated to determine the residual risk for the transaction.

From step 405, the process shows that at least one of two paths may be followed. The first path is to step 501, where the overall effectiveness of controls for each transaction may be calculated to determine the residual risk for the transaction. The second path is to step 502, where the forecasted overall effectiveness of controls may be calculated to determine the residual risk for the transaction.

From step 502, the process moves to step 503, where the overall risk score for the application, which may include multiple applications, may be calculated based on the risk scores for each transaction. The path from step 503 leads to step 504, where the risk scores for each individual application may be aggregated to determine the overall risk score for the enterprise as a whole, the line of business within the enterprise, or some small sub-entity within a particular line of business.

Step 507 follows from step 504. Additional inputs to step 507 are from steps 505 and 506. At step 505, the cost of implementing the various one or more controls of the transaction is accounted for in the determination in step 507. At step 506, the impact of the threats to the business is accounted for in the determination in step 507. The impact in step 506 may include the impact of the threat(s) on consumer confidence, performance and usability, capacity and business continuity, cross channel, regulatory impact, operational impact, credit impact, and market impact. Proceeding to step 507, in response to the inputs from steps 505 and 506, the appropriate level of controls needed based on the cost of implementing controls and the impacts of attack against consumer confidence, speed and usability, and capacity and business continuity may be determined.

It should be noted that the flow chart in FIGS. 1A-1B is illustrative and, unless otherwise specified, the order of the steps is not necessarily binding on the invention. Accordingly, the steps may be performed in an order or sequence other than as shown without departing from the spirit and nature of the invention.

Furthermore, certain methods according to the invention may be sub-methods of the entire method shown in FIGS. 1A-1B. As such, fewer than all the steps may be claimed in the claims which follow this specification without departing from the spirit and nature of the invention.

The following is an illustrative implementation of a method according to the invention. It should be understood that the order of the following steps is but one order of steps according to the invention, and other orders of steps are possible according to the invention.

1. The customer facing applications/services for categorization are extracted by an

Application Inventory Tool (AIT) (the application criteria for Risk Assessment is a field in the AIT). This inventory may be performed according to a line of business (LOB) or some other sub-entity, within an enterprise.

2. The LOB's identified customer-facing applications/services are reported to the Line of Business Application Owners (LOB) contact name(s) listed in the AIT.

3. The Line of Business Application Owners (LOB) and Technical Support are requested to identify the customer-facing applications' transactions authentication controls and to rank the risk level (High, Medium, Low) for the transaction's transaction, reputation and financial risks.

4. The LOB and Technical Support complete and submit the transaction Data Collection Form to be assessed.

5. The transaction's total risk, e.g., percent of risk relative to the risk associated with other transactions or independently from other transactions, using the results of the risk level ranking is calculated and the authentication controls category, e.g., front (pre-transaction), transaction, and backend (post-transaction), is determined.

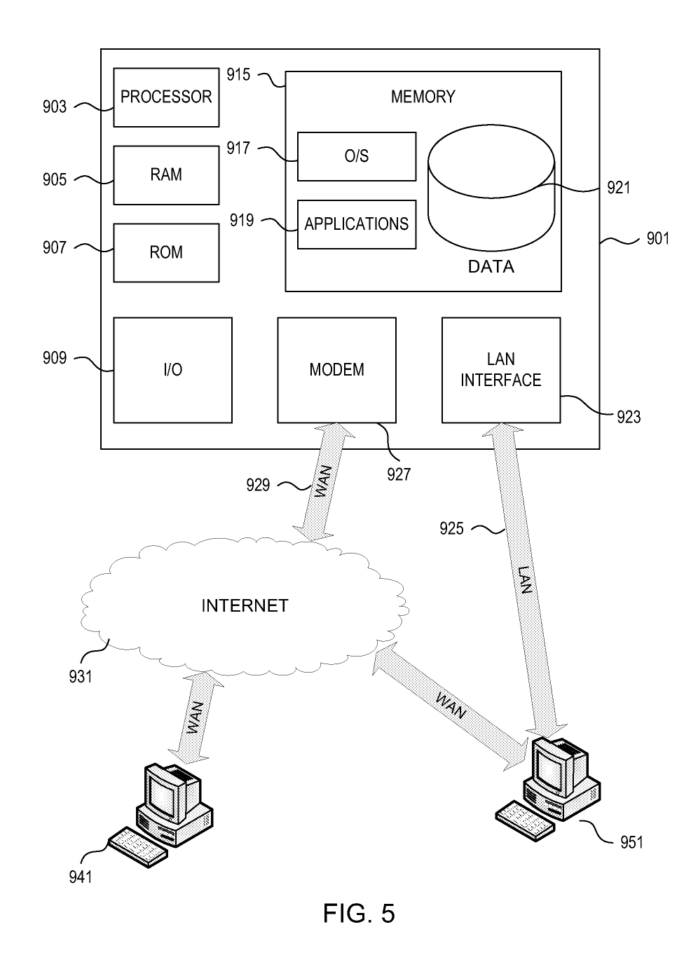

6. The transactions' residual risk scores are calculated using the information provided by a threat management and risk forecasting process, as disclosed in more detail below in the portion of the specification corresponding to FIGS. 5-14.

7. The application's total residual risk score is calculated.

8. The application's risk assessment report is created and distributed to the LOB and Technical Support for validation.

9. Feedback is received and the application's total residual risk score is recalculated.

10. The risk assessment report is updated and distributed to appropriate distribution list (LOB's Information Security Officer (ISO), Senior Leadership Team (SLT) and Chief Information Officer (CIO). One purpose of such a communication is to communicate the results of the risk assessments.

11. A review meeting is scheduled to review results and determine next steps for applications with total residual risk scores above the information security approved authentication threshold.

12. A decision is made to accept the risk, LOB documents and provides information security business continuity authentication and information security personnel with decision to accept risk at this time. This decision may be flagged for review risk in 12 months.

13. Either together with, or alternatively to, step 12, a LOB may make a decision to mitigate the risk and form a mitigation workgroup to determine the appropriate available authentication controls.

14. Assuming that a line of business or other suitable sub-entity followed the path in step 13 as an alternative to accepting the risk, as shown in step 12, then the line of business may update a transaction data collection form with the planned additional authentication controls and submit for assessment to determine a new residual risk score for the application.

15. The line of business may develop the application mitigation plan to implement additional authentication controls.

In one further embodiment of the invention, a process may provide at predetermined intervals, such as yearly, new authentication controls and updates to already-existing authentication controls. One embodiment of such a process may be instituted using the threat management and risk forecasting system described below. Such updates may also include the percent of effectiveness of the controls against the threats to be used in the risk assessment process according to the invention.

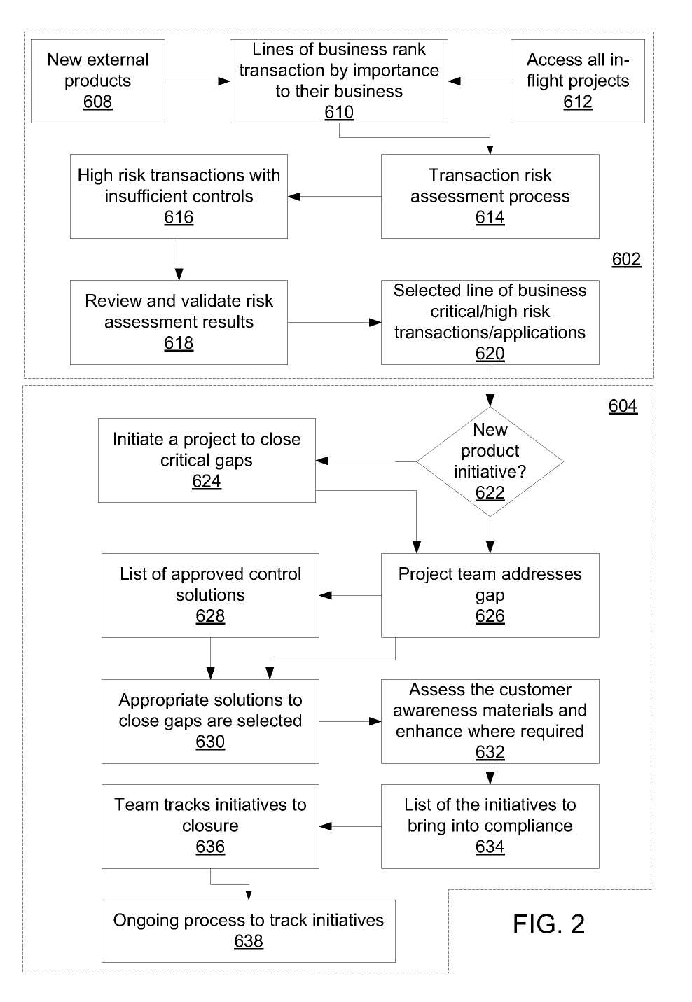

FIG. 2 is an authentication risk assessment process according to one or more aspects of the invention. FIG. 2 preferably includes two sub-parts. First, FIG. 2 includes a flow diagram illustrating an authentication risk assessment process. The process includes two branches, a risk assessment branch 602 and an authentication risk gap closure/update customer awareness branch 604.

Risk assessment branch includes identification or other determination of new external product initiatives at step 608. At step 610, the lines of business, or other suitable sub-entity within an enterprise, rank the transaction by importance to their respective business. At step 610, the ranking may ranking by importance, some or all in-flight projects, as received from step 612.

A transaction risk assessment process, such as, for example, the process shown in FIGS. 1A-1B above, or the process described below, may be implemented at step 614. The process may be continued in order to identify high risk transactions with insufficient controls, as shown in step 616. When such transactions have been identified, the lines of business may review and validate such risk assessment results, as shown in step 618.

Following the review and validation, the selected line of business may determine critical/high risk transactions/applications as shown in step 620. In such circumstances that are determined to be suited for transition to a new product initiative, as shown at step 622, the authentication risk gap closure/update customer awareness process 604 may be initiated.

If a new product initiative is undertaken in response to step 622, then the LOBs can engage an ISBC (information security business continuity) consultant, an Information Security architect, LOB Tech Support, a network computing group consultant, an information security Authentication consultant, or some other consultant as shown in step 626. Alternatively, if a new product initiative is not undertaken in response to step 622, then the LOBs may initiate a project to close critical gaps to comply with Authentication Guidance, as shown in step 624. Eventually, step 624 may lead to step 626, as described in more detail previously.

Two possible outcomes from step 626 are shown. First, an intermediate step including identifying a list of approved control solutions, as shown in step 628, may be implemented, or the LOBs may directly select the appropriate control solutions to close gaps and comply with the FFIEC Authentication Guidance, as shown in step 630.

Following the selection of appropriate solutions at step 630, the process may assess the customer awareness materials and enhance the materials where required, as shown in step 632. This assessment may generate a list of initiatives to bring the new product into FFIEC authentication compliance, as shown in step 634.

An authentication team may track initiatives to closure of the authentication risk gap, as shown in step 636. Finally at step 638, a possible enhancement of the process may occur where an ongoing process may be implemented to track initiatives following the introduction of a new initiative and/or product.

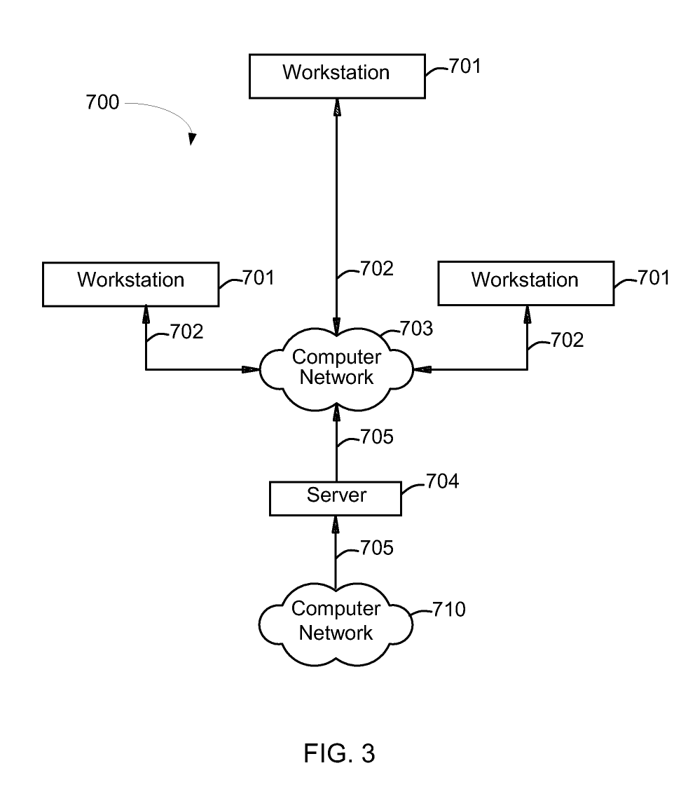

Referring to FIG. 3, an illustrative system 700 for implementing methods according to the present invention is shown. As illustrated, system 700 may include one or more workstations 701. Workstations 701 may be local or remote, and are connected by one or communications links 702 to computer network 703 that is linked via communications links 705 to server 704. In system 700, server 704 may be any suitable server, processor, computer, or data processing device, or combination of the same. Server 704 may be used to process the instructions received from, and the transactions entered into by, one or more participants.

Computer network 703 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 702 and 705 may be any communications links suitable for communicating between workstations 701 and server 704, such as network links, dial-up links, wireless links, hard-wired links, and the like.

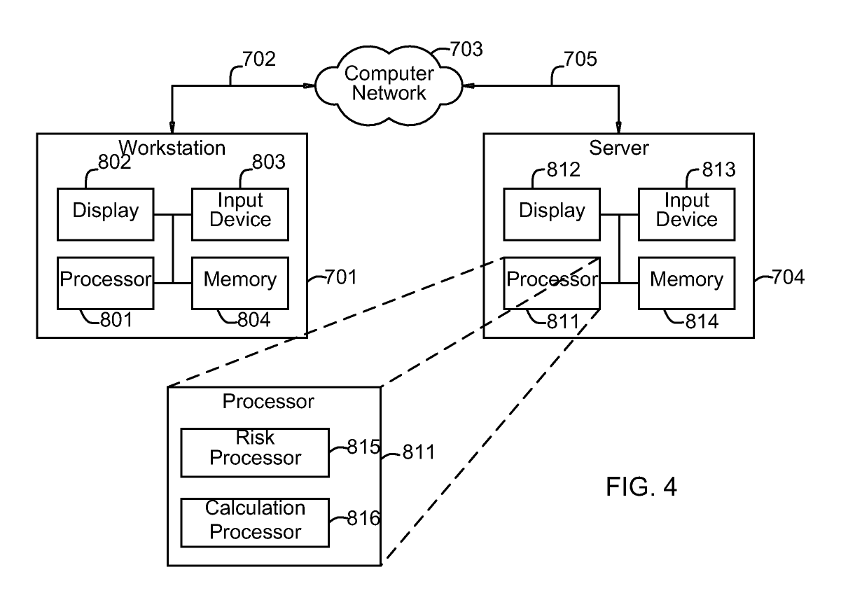

The server and one of the workstations, which are depicted in FIG. 3, are illustrated in more detail in FIG. 4. Referring to FIG. 4, workstation 701 may include processor 801, display 802, input device 803, and memory 804, which may be interconnected. In one embodiment, memory 804 may contain a storage device for storing a workstation program for controlling processor 801. Processor 801 uses the workstation program to present, on display 802, information relating to process functions to a user of workstation 701. Such transaction information may include transaction information relating to risk assessment and/or threat assessment. Furthermore, input device 803 may be used to receive information relating to threats and/or risks associated with applications.

Server 704 may include processor 811, display 812, input device 813, and memory 814, which may be interconnected. In one embodiment, memory 814 may contain a storage device for storing transaction information relating to the transactions entered into by users implementing processes, and/or users inputting necessary information for processes, according to the invention. The storage device may further contain a server program for controlling processor 811. Processor 811 may use the server program to implement one or more of the processes according to one or more aspects of the invention. Processor 811 may include risk calculation processor 815 that calculates the risk assessments that are used in the processes according to the invention. Processor 811 also may include threat processor 816 that may also calculate the relative value and scope of threats. It should be noted that all references herein to processors may be understood to include multiple processors performing a portion (or all) of a single task or, alternatively, a single processor performing multiple processes.

FIG. 5 illustrates a block diagram of a generic computing device 901 (e.g., a computer server) that may be used according to an illustrative embodiment of the invention. The computer server 901 may have a processor 903 for controlling overall operation of the server and its associated components, including RAM 905, ROM 907, input/output module 909, and memory 915.

I/O 909 may include a microphone, keypad, touch screen, and/or stylus through which a user of device 901 may provide input, and may also include one or more of a speaker for providing audio output and a video display device for providing textual, audiovisual and/or graphical output. Software may be stored within memory 915 and/or storage to provide instructions to processor 903 for enabling server 901 to perform various functions. For example, memory 915 may store software used by the server 901, such as an operating system 917, application programs 919, and an associated database 921. Alternatively, some or all of server 901 computer executable instructions may be embodied in hardware or firmware (not shown). As described in detail below, the database 921 may provide centralized storage of account information and account holder information for the entire business, allowing interoperability between different elements of the business residing at different physical locations.

The server 910 may operate in a networked environment supporting connections to one or more remote computers, such as terminals 941 and 951. The terminals 941 and 951 may be personal computers or servers that include many or all of the elements described above relative to the server 901. The network connections depicted in FIG. 5 include a local area network (LAN) 925 and a wide area network (WAN) 929, but may also include other networks. When used in a LAN networking environment, the computer 901 is connected to the LAN 925 through a network interface or adapter 923. When used in a WAN networking environment, the server 901 may include a modem 927 or other means for establishing communications over the WAN 929, such as the Internet 931. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 919 used by the server 901 according to an illustrative embodiment of the invention may include computer executable instructions for invoking user functionality related to communication, such as email, short message service (SMS), and voice input and speech recognition applications.

Computing device 901 and/or terminals 941 or 951 may also be mobile terminals including various other components, such as a battery, speaker, and antennas (not shown).

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and the like that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

One or more aspects of the present invention are directed to a model/tool that enables an organization to proactively identify information security and business continuity (ISBC) threats related to a project or strategic initiative within a line of business and the controls associated with these threats. In addition, the effectiveness of these controls is provided to allow the organization to properly anticipate the risk associated with that project or strategic initiative. Such information then enables the organization to make appropriate resource allocation decisions to mitigate these residual risks by implementing new controls and/or changing elements of the strategic initiative. The tool may also incorporate other risk factors, such as supplier compliance to security practices and contractual obligations, regulatory compliance, and the like, in calculating residual risk for an initiative or project. All these factors may be forecasted for residual risk reporting over a predetermined period, such as an eighteen month horizon, for the organization to make appropriate planning decisions.

Many observations, audits, vulnerability assessments, risk assessments, and the like surface a large number of risks in the current environment. As these risks are surfaced, lines of businesses are challenged with determining how to respond to the risks identified. Challenges include determining how to best prioritize identified risks and how to load balance resources to respond. Additionally, knowing that not all risks can be controlled or optimized there is limited strategy currently available that assists with forward projection of risk.

What is needed is a system and method that enables an organization to proactively identify Information Security and Business Continuity (ISBC) threats related to a project or strategic initiative within a line of business and the controls associated with these threats.

Aspects of the present invention may utilize a standardized taxonomy, e.g., classification system, to decompose threats and initiatives which are correlated to each other to identify critical dependencies/vulnerabilities. Controls may act upon threats to mitigate the threats impact. For example, anti-virus software on a computer mitigates the threats posed by computer viruses. The system may classify all the major ISBC controls at the organization based on their ability to mitigate threats.

Aspects of the present invention provide a consistent and robust model for derivation of residual risk using the correlation of business requirements, threats, controls and other risk factors, e.g., business continuity, supplier, compliance, and the like. The resultant residual risk enables management to make appropriate plans to mitigate risks and obtain a profile of the current state and forecast the anticipated changes in the correlated values. The ability to track against a baseline provides the opportunity to either reduce the residual risk or mitigate further increases.

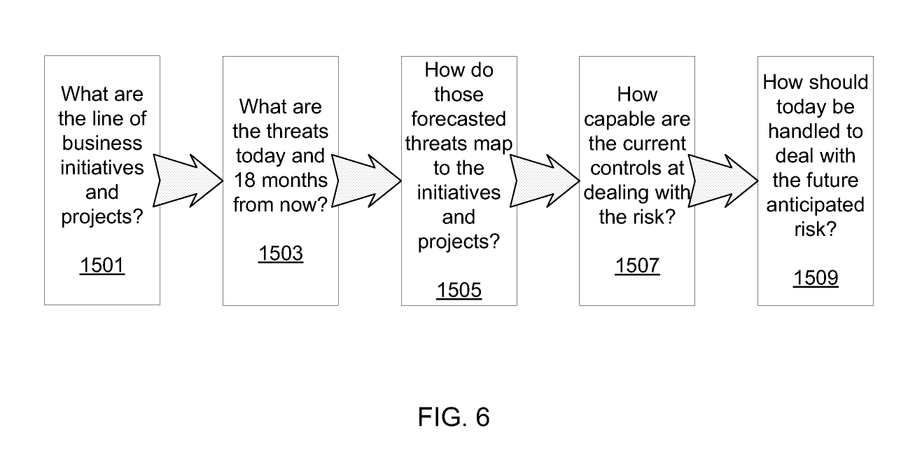

FIG. 6 is an example flowchart illustrating questions asked and steps taken to model threats and their potential impact on a business entity in accordance with at least one aspect of the present invention. With respect to the question of what are the line of business initiatives and projects posed in step 1501, line of business/business unit strategic initiatives are identified and a Hoshin plan is implemented to support the initiatives and projects. The basic premise behind a Hoshin plan is that the best way to obtain the desired result is to ensure that all employees in an organization understand the long-range direction and that they are working according to a linked plan to make the vision a reality. The second aspect of the plan is that there are fundamental process measures which must be monitored to assure the continuous improvement of the organization's key business processes. In essence, all are heading in the same direction with a sense of control. Further in response to the question posed in step 1501, a project is defined to accomplish the identified strategic initiative, and information security and business continuity become involved.

With respect to the question of what are the threats today and in eighteen months from today posed in step 1503, a process is employed for identification of potential threats to the organization. Identification is conducted by obtaining data and opinions from diverse threat knowledgeable sources. All source data is analyzed to create a threat profile for respective projects and quantitative and qualitative predictive analysis is used to create rolling eighteen month forecast for each threat. With respect to the question of how do the forecasted threats map to the initiatives and projects posed in step 1505, the strategic initiatives and projects are rated based upon the likely threats that may apply and the threats are profiled and forecasted independent of any vulnerabilities.

With respect to the question of how capable are the current controls at dealing with the risk posed step 1507, the current controls of the system are identified and specific controls are correlated to specific threats. The mitigating impact of the controls and the threats, e.g., the strength of the control, is then determined and the maturity of the controls is assessed. The future state of the controls is also forecasted. Finally, with respect to the question of how should today be handled to deal with the future anticipated risk posed in step 1509, the current and forecasted state of each threat is ranked over a rolling eighteen month horizon. Business portfolio category ratings are assessed using the current and forecasted residual threat states, and the ranking of current and future business portfolio residual impact is evaluated as a basis for resource allocation.

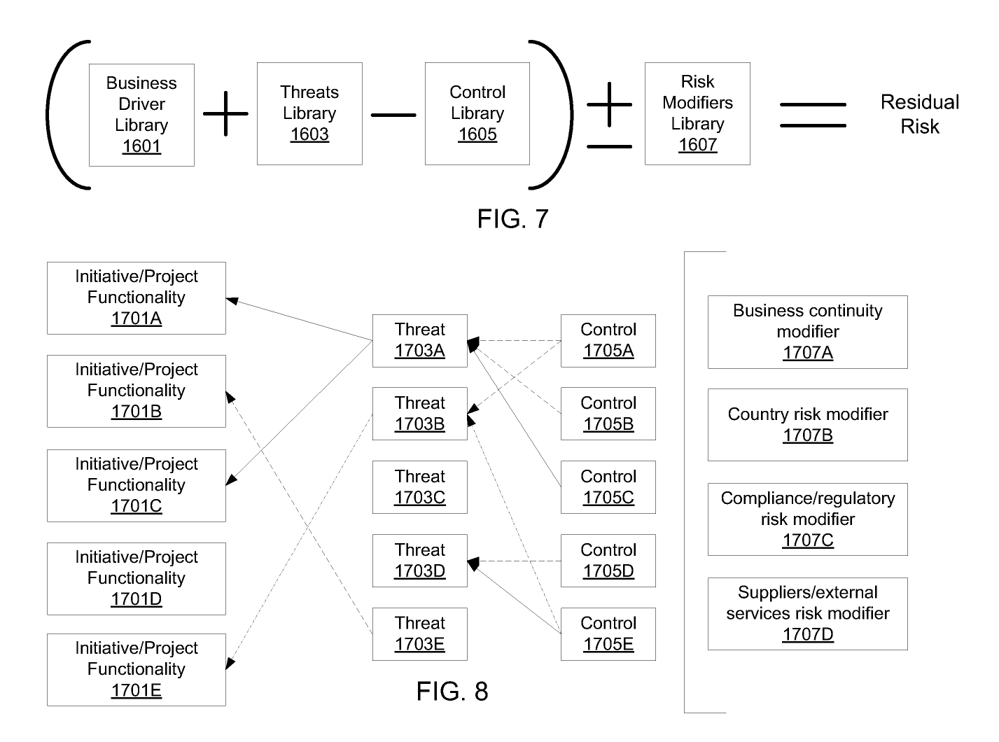

FIG. 7 is an illustrative equation for the interaction and uses of various libraries in accordance with at least one aspect of the present invention. One or more aspects of the present invention utilize various libraries of data with respect to different components of an equation to determine the residual risk associated with an initiative and project. Ranked threats in a library 1603 affecting business initiatives in a library 1601 are offset by controls for threats stored in a library 1605 and are further affected by risk modifiers maintained in a library 1607. The remaining risk amounts to residual risk that should be addressed. A business driver library 1601 may include strategic plans and/or Hoshin objectives that drive long term and tactical business initiatives. Risk profiles for these initiatives may be included in the overall model to support risk forecasting. The business driver library 1601 accounts for the vulnerabilities of the overall risk equation.

A current and emerging threats library 1603 may include operational asset data combined with current and emerging threat information to create vulnerability and risk profiles. Industry threat information updates may be captured to create updated threat profiles. The current and emerging threats library 1603 accounts for the threats of the overall risk equation. A mitigation and controls library 1605 maintains current environment profiles, where risk mitigation efforts are evaluated, modified, and incorporated as the status of the efforts change. Existing controls may be monitored for effectiveness, and any decrease in performance may be reflected back into the current environment profile. The mitigation and controls library 1605 accounts for the countermeasures or likelihood of the overall risk equation.

Finally, a risk modifiers library 1607 may include instances where a risk exposure level is not directly tied to a particular line of business. Such instances may be addressed by either applying a standard adjustment to all exposed areas or by allocating proportions of risk to the business based upon its' activity. Examples of these modifiers include the business continuity impact, the country impact, compliance/regulatory, and suppliers/external services. Examples of business continuity impact include a business impact analysis, business continuity threats, such as weather, building, geology or other natural threats and social disorder, intentional, and other man-made threats, line of business recovery plans, and line of business readiness. Examples of country impact include the countries in which the initiative will occur, potential regional impact within the country, and interaction between the countries in the initiative. Examples of compliance/regulation include any significant compliance element impacting an initiative, previous regulatory loss experiences, and utilization of compliance tracking scores. Examples of suppliers/external services include external suppliers used or an initiative, an assessment of reliance on a supplier for functionality, and utilization of vendor/supplier tracking scores.

FIG. 8 illustrates an example block diagram of interactions between various components in accordance with at least one aspect of the present invention. As illustrated, various initiative/project functionalities 1701A-1701E may be affected by one or more threats 1703A-1703E with varying degrees of impact on the initiative/project functionalities 1701A-1701E. In the illustrative example shown in FIG. 8, the solid black arrows from the threats 1703 to the functionalities 1701 illustrate a high impact, the dashed line arrow illustrates a moderate impact, and the dashed and dotted line arrow illustrates a low impact.

Controls 1705A-1705E offset the effects of threats 1703 on the functionalities 1701. In the illustrative example shown, the solid black arrows from the controls 1705 to the threats 1703 illustrate a high effectiveness on the threat 1703 by the control 1705, the dashed line arrow illustrates a moderate effectiveness, and the dashed and dotted line arrow illustrates a low effectiveness. Modifiers 1707A-1707D illustrates various risk modifiers that may have positive or negative impacts on increasing or reducing residual risk when applied to one or more of the components 1701A-1705E in FIG. 8.

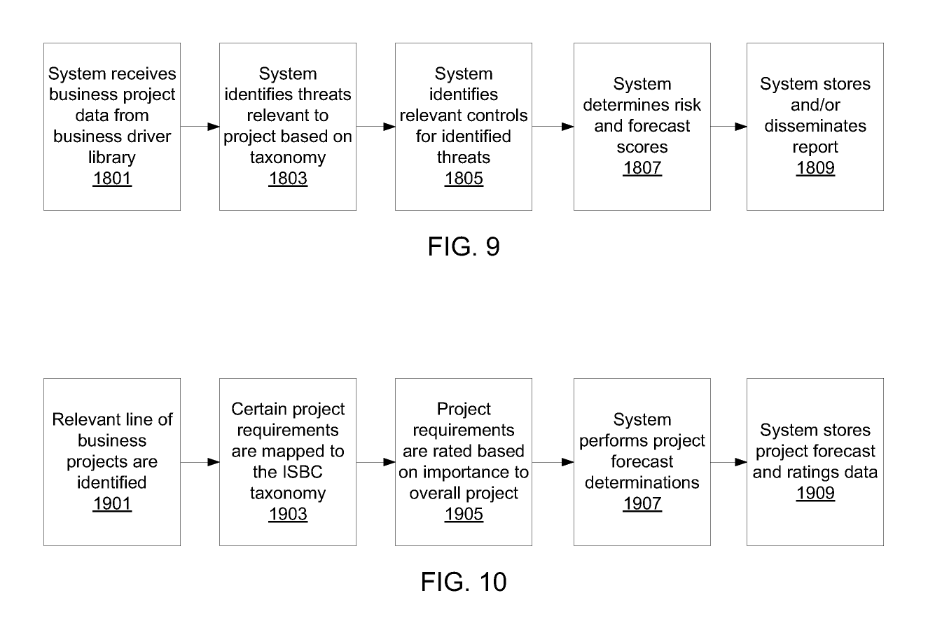

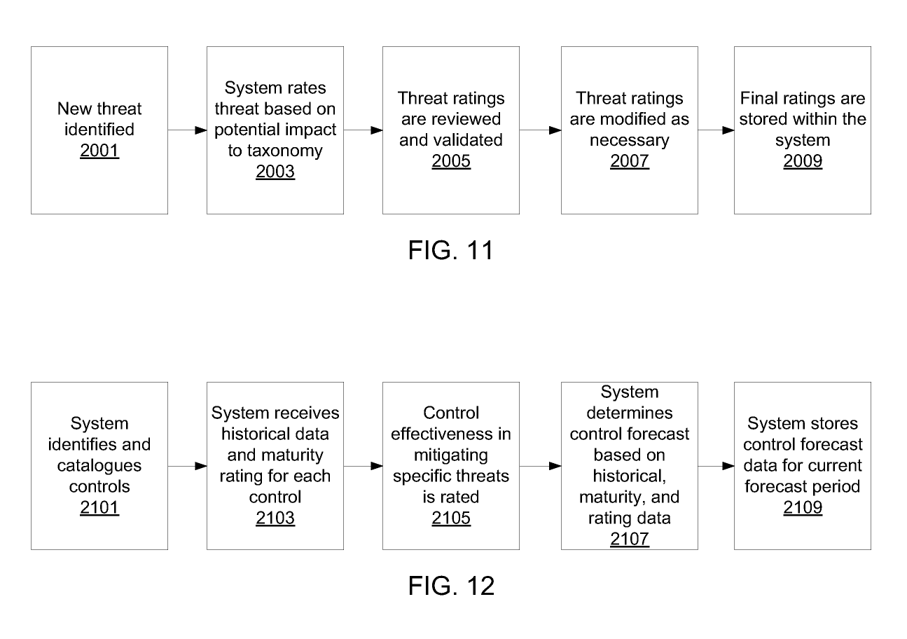

FIG. 9 is an example flowchart illustrating a process for forecasting risk associated with a project in accordance with at least one aspect of the present invention. The process starts and in step 1801, the system receives business project data from the business driver library, such as business driver library 1601 in FIG. 7. The business project data from the business driver library may be the project forecast and ratings data described with respect to FIG. 10 below. In step 1803, the system identifies threats relevant to the project based upon a taxonomy. Such a taxonomy may be a standardized taxonomy, such as the information security and business continuity (ISBC) taxonomy. As should be understood by those skilled in the art, the ISBC taxonomy is but one type of taxonomy and other taxonomies may be utilized in its place. As described herein, the illustrative figures utilize the ISBC taxonomy but the present invention is not so limited. The identification of threats is further described below with respect to FIG. 11.

Proceeding to step 1805, the system identifies relevant controls for the identified threats. The identification of relevant controls is further described below with respect to FIG. 12. In step 1807, the system determines the residual risk and forecast scores for the project. Then, in step 1809, the system may store and/or disseminate a report of the total residual risk for the project/initiative. Such a report may be utilized to further address risk associated with a project.

FIG. 10 is an example flowchart illustrating a process for addressing business initiatives in accordance with at least one aspect of the present invention. The process starts and in step 1901, the relevant line of business projects are identified as needing to be addressed. In step 1903, certain project requirements are mapped to the ISBC taxonomy. As previously indicated, it should be understood that the ISBC taxonomy is merely illustrative and other taxonomies may be utilized in accordance with one or more aspects of the present invention.

Moving to step 1905, the project requirements are rated based on the importance of the requirement to the overall project. At step 1907, the system performs project forecast determinations for how the project and its requirements will evolve over a specific period, such as an eighteen month period. In step 1909, the system may store the project forecast and ratings data in a storage device, such as in business driver library 1601 in FIG. 7.

FIG. 11 is an example flowchart illustrating a process for rating threats in accordance with at least one aspect of the present invention. The process starts and at step 2001, new threats are identified. As described above, in these examples, the identified threats are ISBC threats. In step 2003, the system assigns rates each threat based on the potential impact to the ISBC taxonomy.

Proceeding to step 2005, the assigned threat ratings may reviewed and validated per respective threat. In step 2007, the threat ratings may be modified as necessary in response to the review and validation in step 2005. Then, in step 2009, the final ratings are stored within the system, such as in threats library 1603 in FIG. 7.

FIG. 12 is an example flowchart illustrating a process for maintaining a control library in accordance with at least one aspect of the present invention. The process starts and at step 2101, the system identifies and catalogues controls with respect to the initiative/project. In step 2103, the system receives historical data and a maturity rating for each control. Proceeding to step 2105, the effectiveness of a control in mitigating specific threats is rated by the system. Based on the historical, maturity, and rating data, the system determines a forecast of the control in step 2107. Such a forecast is a determination of how the control will evolve over a specific period, such as an eighteen month period. Then, in step 2109, the system stores the control forecast data for a current forecast period. The system may store such information in a library, such as control library 1605 in FIG. 7.

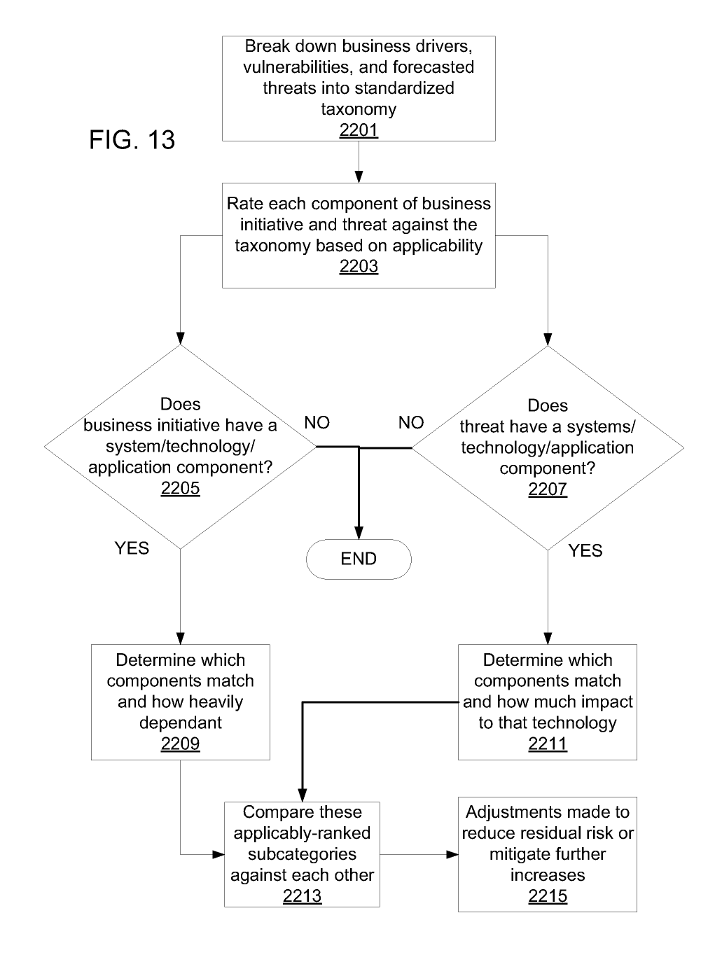

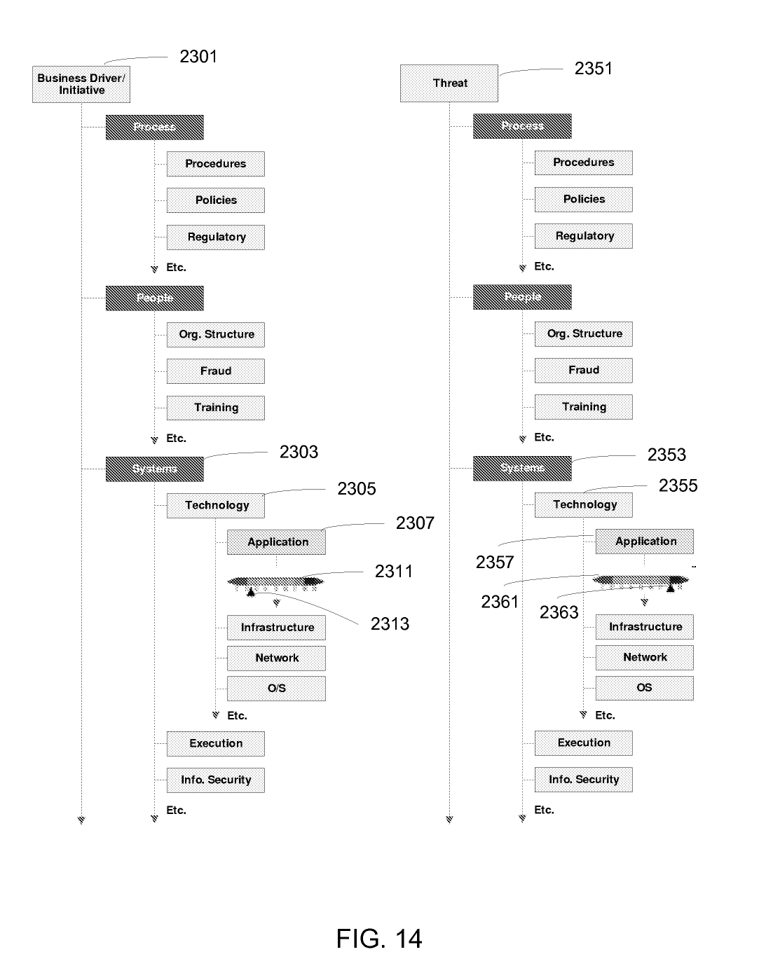

FIG. 13 is an example flowchart illustrating a process for determining a relationship between a business driver and a forecasted threat in accordance with at least one aspect of the present invention. As previously described with respect to FIGS. 9-12, step 2201 provides for the breakdown of business drivers, vulnerabilities, and forecasted threats into a standardized taxonomy, such as ISBC taxonomy. A component tree may be generated with respect to each and every component of the business initiative/project.

FIG. 14 is a block diagram of an illustrative tree identifying various components of a business driver/initiative and a forecasted threat in accordance with at least one aspect of the present invention. In FIG. 14, reference element 2301 identifies the business drivers/initiatives. In the example shown in FIG. 14, business driver 2301 includes a Systems component 2303. Included within Systems component 2303 is a Technology component 2305, and within Technology component 2305 is an Application component 2307.

Also included within FIG. 14 is a breakdown of the forecasted threats 2351 into a standardized taxonomy. In the example shown in FIG. 14, threat 2351 includes a corresponding Systems component 2353. Included within Systems component 2353 is a Technology component 2355, and within Technology component 2355 is an Application component 2357.

With the business drivers, vulnerabilities, and forecasted threats broken down into a standardized taxonomy in step 2201, the process moves to step 2203 where each component of the business driver/initiative and threat against the taxonomy is rated based on the applicability of the component. With respect to the example shown in FIG. 14, the Application component 2307 is shown to include a rating 2313 on a scale 2311. In such an example, the rating may indicate how dependent the overall project is to that Application component 2307. In this example, the rating 2313 is shown as to the far left on the scale 2311, which may indicate a rating that is very low to indicate that the overall project does not heavily depend on Application component 2307.

Also shown is that corresponding Application component 2357 for threat 2351 includes a rating 2363 on a scale 2361. In such an example, the rating may indicate how much of an impact that threat would have on such an Application component 2357. In this example, the rating 2363 is shown as to the far right on the scale 2361, which may indicate a rating that is very high to indicate that the threat does have a high impact on an Application component 2357.

Returning to FIG. 14 and proceeding to step 2205, a determination is made as to whether the business driver/initiative 2301 has a Systems/Technology/Application component 2307 to match a corresponding Application component 2357 in the threat 2351. Concurrently, a determination is made in step 2207 as to whether the threat 2351 has a Systems/Technology/Application component 2357 to match corresponding Application component 2307. If the answer to both steps 2205 and 2207 is yes, the process moves to steps 2209 and 2211, respectively.

In step 2209, the system determines which of all the components of the business driver/initiative 2301 match and how heavily dependent the overall project is on the matching components, such as Application component 2307. In step 2211, the system determines which of all the components of the threat 2351 match and how much of an impact the threat will have on the matching components, such as Application component 2357. The information from steps 2209 and 2211 are forwarded to step 2213 where the applicably-ranked matching subcategories are compared against each other. In step 2215, adjustments may be made based upon the compared ratings to reduce the overall residual risk associated with a project and/or to mitigate further increases in residual risk over time.

One or more aspects of the present invention for forecasting risk associated with a project may include an algorithm for calculating risk from a threat. Table 1 below is an illustrative table for a scoring system used with an algorithm for calculating a threat metric score associated with a particular threat. As should be understood by those skilled in the art, the below Table 1 is but one illustrative table and that other formats may be utilized to model threats and their impact on an entity.

TABLE 1

| Score | 1. Maturity | 2. Adoption | 3. Impact |
|---|---|---|---|
| 10 | <1 year | >100% increase in the | High |
| | | last 180 day cycle | |
| 8 | <18 months | >80% increase in the | Moderately |
| | | last 180 day cycle | High |
| 5 | <2 years | >50% increase in | Moderate |
| | | last 180 day cycle | |
| 3 | <4 years | 30% increase in the | Moderately |
| | | last 180 day cycle | Low |
| 1 | >5 years | <10% increase in | Low |
| | | last 180 day cycle | |

In the example in Table 1, an algorithm may be utilized to calculate a threat metric score. For an example of malware, in determining the forecasted impact of a 25% increase in a new vector of viruses over the last 180-day cycle and utilizing the scoring system from Table 1, a threat metric score may be determined by:

Threat Metric Score==[2^{M1(s)}+2^{M2(s)}+2^{A(s)}+2^{I(s)}]/16,

where M1 represents a current maturity rating for a control on the threat, M2 represents a forecasted maturity rating for the control on the threat, A represents the historical adoption of the threat over the last 180-day cycle, and I represents the forecasted impact of the threat. In the illustrative example above, the threat metric score or forecasted score would be 12.5. Such an indication may be correlated against a secondary table to identify the significance of the impact. For example, a score from 0-17 may indicate the impact on the overall project to be significantly decreased. A score from 18-49 may indicate the impact to be moderately decreased. A score from 50-113 may indicate the impact to be stable/no change. A score from 114-193 may indicate the impact to be moderately increased, and a score from 194-256 may indicate the impact to be significantly increased.

This scoring system as described herein may be utilized as part of the determination made with respect to step 2107 in FIG. 12. As should be understood by those skilled in the art, the above is but one example scoring metric system and other calculations may be utilized to determine a forecasted score.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for managing risk associated with various transactions according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. One or more computer-readable media storing computer-executable instructions which, when executed by a processor on a computer system, perform a method comprising:
receiving an identification of a list of threats to a software-based consumer transaction;
categorizing each of the threats in the list into a threat category;
forecasting an impact of each of the threats in the list; and
calculating an overall impact of the threats in the list based on the forecasted impact of each of the threats in the list.

2. The one or more computer-readable media of claim 1, the instructions which, when executed by the processor on the computer system, perform a method comprising forecasting an effectiveness of controls based on the forecasted impact of each of the threats in the list.

3. The one or more computer-readable media of claim 1, the instructions which, when executed by the processor on the computer system, perform a method comprising aggregating the threats in each threat category and forecasting an impact of the threats in each threat category.

4. One or more computer-readable media storing computer-executable instructions which, when executed by a processor on a computer system, perform a method comprising:
receiving an identification of a plurality of threats to a user transaction in a user-facing software application;
receiving an identification of a plurality of threat controls that control at least a portion of the plurality of threats;
identifying control effectiveness against each of the plurality of threats; and
calculating an overall effectiveness score of the threat controls based on mitigating an effect of the plurality of threats on the user transaction.

5. The one or more computer-readable media of claim 4, the instructions which, when executed by the processor on the computer system, perform a method comprising:
forecasting a threat profile; and
forecasting overall effectiveness of the threat controls based on the threat profile.

6. The one or more computer-readable media of claim 4, the instructions which, when executed by the processor on the computer system, perform a method comprising classifying the plurality of threats into a plurality of threat categories.

7. The one or more computer-readable media of claim 4, the instructions which, when executed by the processor on the computer system, perform a method comprising aggregating a plurality of overall effectiveness scores for a plurality of user transactions in the consumer-based software application.

8. One or more computer-readable media storing computer-executable instructions which, when executed by a processor on a computer system, perform a method comprising:
identifying a consumer-based software application for risk analysis;
classifying the consumer-based software application into a plurality of consumer-facing transactions;
rating each consumer-facing transaction according to at least one risk category;
converting each rated consumer-facing transaction into a numeric value;
receiving an identification of a list of threats to each of the consumer-facing transactions;
categorizing the threats into threat categories;
forecasting an impact of each threat;
calculating an overall impact of the threats based on the forecasted impact;
receiving an identification of a plurality of threat controls that control at least a portion of the plurality of threats;
identifying control effectiveness of the plurality of threat controls against each of the plurality of threats; and
calculating an overall effectiveness score of the plurality of threat controls based on mitigating an effect of the threats on each of the consumer-facing transactions.
